(19) United States
(12) Patent Application Publication
(10) Pub. No.: US 2024/0193546 A1
(43) Pub. Date: Jun. 13, 2024

(54) AUTOMATED POLICY COMPLIANCE

(71) Applicant: Red Hat, Inc., Raleigh, NC (US)

(72) Inventors: Thalia Hooker, Saint Paul, MN (US); Timothy Ross Coulter, Carson City, NV (US); Mark Parzygnat, Raleigh, NC (US); Marc Loos, Amsterdam (NL); Thomas Edward Creamer, Tallahassee, TN (US)

(21) Appl. No.: 18/080,535

(22) Filed: Dec. 13, 2022

(51) Int. Cl. G06Q 10/101; G06F 16/28; G06F 40/20

(52) U.S. Cl. CPC G06Q 10/101; G06F 16/288; G06F 40/20

(57) ABSTRACT

Techniques for generating policy compliance assets are disclosed. An example method includes receiving a body of training data comprising a policy document and policy action codes that correspond with the policy document, wherein the policy action codes comprise machine-readable computer code for implementing policies contained in the policy document. The method also includes processing the policy document to generate a structured dataset of policy actions. The method also includes generating, by a processing device, a trained model to create a mapping between the policy actions and the policy action codes. The method also includes receiving a new policy document from a client device and generating new policy action codes from the new policy document using the trained model. The method also includes sending the new policy action codes to the client device.

### TECHNICAL FIELD

Aspects of the present disclosure relate to techniques for automatically generating policy compliance products, such as policy documents and computer programming code.

### BACKGROUND

Certifications such as those issued by the International Organization for Standardization (ISO) provide assurance to customers, and potential customers that there is a rigor and discipline to the operational aspects of an enterprise. Getting compliance certifications and achieving alignment between a company's technologies and stated policies can help businesses ensure consistent high-quality products and services and may help attract new customers.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram of an example of a computer system in accordance with some embodiments of the present disclosure.

FIG. 2 is a block diagram of an example standards processor in accordance with some embodiments of the present disclosure.

FIG. 3 is a block diagram of an example asset generator in accordance with some embodiments of the present disclosure.

FIG. 4 is another example of an asset generator in accordance with some embodiments of the present disclosure.

FIG. 5 is a block diagram of another example system in accordance with some embodiments of the present disclosure.

FIG. 6 is a process flow diagram summarizing a method of automatically performing an audit using generated compliance assets, in accordance with some embodiments of the present disclosure.

FIG. 7 is a process flow diagram summarizing a method of automatically generating compliance assets, in accordance with some embodiments of the present disclosure.

FIG. 8 is a simplified block diagram of a system for automatically generating compliance assets, in accordance with some embodiments of the present disclosure.

FIG. 9 is a process flow diagram summarizing another method of automatically generating compliance assets, in accordance with some embodiments of the present disclosure.

FIG. 10 is a simplified block diagram of another system for automatically generating compliance assets, in accordance with some embodiments of the present disclosure.

FIG. 11 illustrates a diagrammatic representation of a machine in the example form of a computer system within which a set of instructions, for causing the machine to perform any one or more of the methodologies discussed herein, may be executed.

### DETAILED DESCRIPTION

Aspects of the present disclosure relates to techniques for automatically generating policy compliance assets that can be used to achieve compliance with one or more standards such as ISO standards. Some standards may apply to policies that govern the operations of a company or other organization. Some standards may apply to the fabrication or operation of a service or product. In either case, the conventional process for developing and implementing policy goals and ensuring compliance is a time-consuming labor-intensive process.

To set policy goals in the conventional way, appropriate policies are usually written to be in accordance with a specific the compliance standard that the company wishes to adhere to or that applies to a particular product. These written policies are reviewed, often by outside experts, to ensure that the policies comply with the given standard. Once the policies are adopted, the technical components affected by the policies are defined, and specific steps are defined for ensuring that the technical components are in alignment with the policy documents. To validate that the technical components are in alignment, the steps are performed, and the results are documented and presented to compliance auditors. These processes are manual labor-intensive processes that are subject to human interpretation and judgement and are therefore prone to error.

Aspects of the disclosure address the above-noted and other deficiencies by providing a system for automatically generating policy compliance assets that can be used to streamline the policy implementation and auditing processes. As used herein, the term “automatic” or “automatically” refers to performance by machines or devices without human involvement. The automatic generation of policy compliance assets may be accomplished through the training of an artificial intelligence model and/or machine learning model such as an artificial neural network, natural language processing, or the like. The model may be trained on a body of training data that includes human-written standards and policies as well as compliance assets that are known to be a product of such standards and policies. The training data may be processed using one or more natural language processors to provide labeled and structured data suitable for training the model.

The generated policy compliance assets may include computer code written in a programming language, e.g., policy-as-code or infrastructure-as-code. Infrastructure as code refers to the use of code-based files to automate infrastructure setup and provisioning. Policy-as-code is the use of code to define and manage rules and conditions that govern IT operations or processes. The policy compliance assets may further include validation code, which may include audit scripts for testing a system for compliance with the policies. Audit scripts may be run against an environment to prove validation and generate the required proof points for the auditors.

The policy compliance assets may also include natural-language policy documentation to be read and used by employees. In this way, the present techniques can fully and seamlessly automate the entire compliance process, from ingestion of the standards, generation of policies, the generation of code in the form, but not limited to, playbooks, policies, policy sets, and rules that enable compliance, and generation of the validation code, which provides the documentation necessary to satisfy audit requirements and proof of compliance.

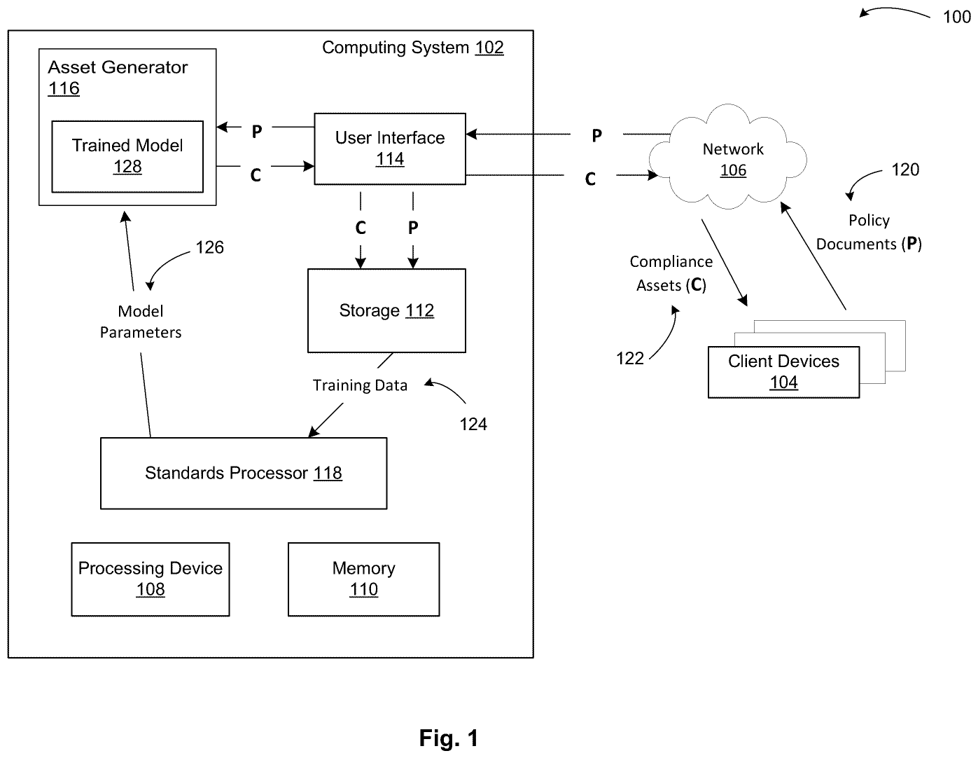

FIG. 1 is a block diagram of an example system 100 in accordance with some embodiments of the present disclosure. One skilled in the art will appreciate that other architectures are possible for system 100 and any components thereof, and that the implementation of a system utilizing examples of the disclosure are not necessarily limited to the specific architecture depicted by FIG. 1. The system 100 may include a computing system 102, which may be coupled to client devices 104 through a network 106. The computing system 102 may be a cloud-based infrastructure configured, for example, as Service as a Service (SaaS) or Platform as a Service (PaaS). The computing system 102 may also be a non-cloud-based system such as a personal computer, one or more servers communicatively coupled through a network, mobile devices, edge devices, and other configurations.

Each client device 104 may be any suitable type of computing device or machine that has a programmable processor including, for example, server computers, desktop computers, laptop computers, tablet computers, smartphones, set-top boxes, etc. In some examples, each of the client devices 104 may comprise a single machine or may include multiple interconnected machines (e.g., multiple servers configured in a cluster). The computing system 102 and client devices 104 may be implemented by a common entity/organization or may be implemented by different entities/organizations.

The network 106 may be a public network (e.g., the internet), a private network (e.g., a local area network (LAN) or wide area network (WAN)), or a combination thereof. In one embodiment, the network 106 may include a wired or a wireless infrastructure, which may be provided by one or more wireless communications systems, such as a WiFi hotspot connected with the network 106 and/or a wireless carrier system that can be implemented using various data processing equipment, communication towers (e.g. cell towers), etc. In some embodiments, the network 106 may be an L3 network. The network 106 may carry communications (e.g., data, message, packets, frames, etc.) between the computing system 102 and the client devices 104.

The computing system 102 can include one or more processing devices 108 (e.g., central processing units (CPUs), graphical processing units (GPUs), etc.), main memory 110, which may include volatile memory devices (e.g., random access memory (RAM)), non-volatile memory devices (e.g., flash memory) and/or other types of memory devices, and a storage device 112 (e.g., one or more magnetic hard disk drives, a Peripheral Component Interconnect [PCI] solid state drive, a Redundant Array of Independent Disks [RAID] system, a network attached storage [NAS] array, etc.). In certain implementations, main memory 110 may be non-uniform access (NUMA), such that memory access time depends on the memory location relative to processing device 108. The storage device 112 may be a persistent storage and may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices. The storage device 112 may be configured for long-term storage of data. It should be noted that although, for simplicity, a single processing device 108, main memory 110, storage device 112, are shown, other embodiments may include a plurality of processing devices, memories, and storage devices. Additionally, the computing system 102 may have additional components not shown in FIG. 1. The client devices 104 may include similar architectures.

The system 100 may be used for automatic generation of compliance assets 122 from policy documents 120. As used herein, policy documents refer to any human-readable, natural-language text documents that describe rules and guidelines to be followed by an enterprise in the course of operating the enterprise, creating a product, and/or providing a service. In some embodiments, the policy documents 120 may be standards published by a standards organization such as ISO, the Center for Internet Security (CIS) (e.g., CIS benchmarks), or the National Institute of Standards and Technology (NIST). In some embodiments, the policy documents 120 may be written by enterprise personnel to conform to such published standards. The policy documents may be in any suitable file format.

Policies documents 120 may be communicated to the computing system 102 through a user interface 114 of the computing system 102. The user interface 114 may be a graphical user interface, Application Programming Interface (API), or others. In addition to the policy documents 120, the client may provide additional information such as a type of compliance asset and format being requested and/or a particular published standard that the policies pertain to. The types of compliance assets that may be requested include policy actions and policy action code. Policy actions refer to structured policy descriptions that are distilled from the natural-language policy documents 120. Policy actions may be either in the form of human-readable labeled data that can guide personnel to understand the policy actions to be applied or for programs to implement policy actions. For example, a policy action may be structured as a subject, an action, and one or more variables.

Policy action code refers to any computer programming code used to implement policies or to test compliance with the policies. For example, the policy action code may refer to policy-as-code, infrastructure-as-code (e.g., Ansible), audit scripts, and others. The policy action code may be written in any suitable programming language, such as Python, C, C++, Ruby, and others. When requesting compliance assets 122, the client or product may specify a particular computing language or type of computing platform for the policy actions code.

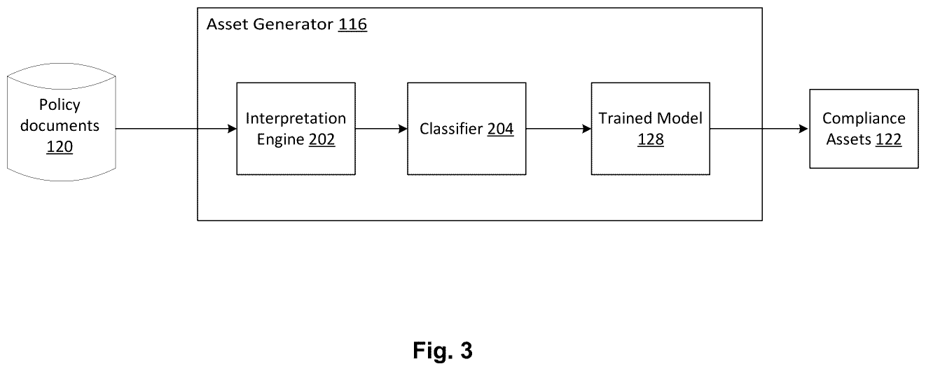

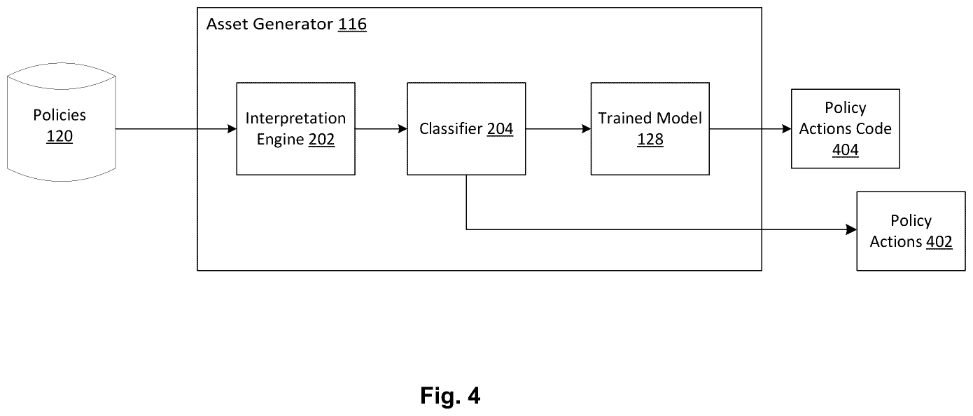

Policies documents 120 may be sent to an asset generator 116. The asset generator 116 receives the policy documents 120 and automatically generates the requested compliance assets 122 from the policy documents 120 using a trained model 128. The trained model 128 may be an artificial intelligence model, machine learning model, neural network, and the like. Although a single trained model is depicted, the asset generator 116 may include several trained models, each of which may be trained to generate a different type of compliance asset. For example, different trained models may be implemented for generating different types of compliance assets for specific computing languages or platform (e.g., Ansible). More detailed examples of an asset generator 116 in accordance with embodiments are shown in FIGS. 3 and 4.

Once generated, the compliance assets 122 may be returned to the client device 104 to be implemented by the client. The compliance assets 122 may be returned to the client device 104 through the user interface 114, as shown in FIG. 1, or through another route such as a shared storage device, email delivery, notification, API, and others.

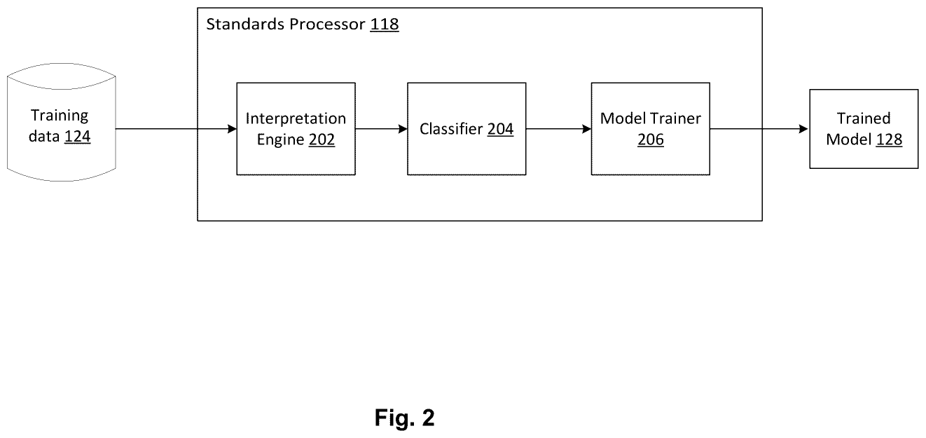

Additionally, the policy documents 120 and the compliance assets 122 may be stored to the storage device 112 and added to a body of training data 124. The training data 124 may be updated as new policy documents 120 and new compliance assets 122 are generated or otherwise become available. In addition to automatically generated compliance assets, the training data 124 can also include manually generated compliance assets. The training data 124 may be periodically retrieved by a standards processor 118, which uses the training data 124 to train the trained model 128, i.e., to generate the model parameters 126 for the trained model 128. A more detailed example of a standards processor 118 in accordance with embodiments is shown in FIG. 2. It will be appreciated that various alterations may be made to the system 100 and that some components may be omitted or added without departing from the scope of the disclosure.

FIG. 2 is a block diagram of an example standards processor 118 in accordance with some embodiments of the present disclosure. The standards processor 118 may be implemented in hardware or a combination of hardware a software and any suitable type of computing architecture.

As described above, the standards processor 118 obtains training data 124 and uses it to generate a trained model 128 that can be used to generate compliance assets 122 (FIG. 1). The standards processor 118 may include an interpretation engine 202, classifier 204, and model trainer 206.

The training data 124 may include several pairs of input data and output data, wherein the input data may include various policy documents 120 and the output data may include corresponding compliance assets 122 that are known to correspond with the input policy documents. The specific policy documents 120 and compliance assets 122 used as training data will depend on the type of compliance asset to be generated by the trained model 128 and the type of policy documents to be used as input to the trained model. For example, if trained model 128 is to be configured to generate Ansible playbooks from manually written company policies, then the training data will include pairs of written company policies (input) and Ansible playbooks (output). The training data can include any suitable number of input training samples and corresponding output training samples.

Before the training data 124 is used to train a model, the training data 124 may undergo one or more pre-processing steps. As shown in FIG. 2, the interpretation engine 202 may receive the input training data (i.e., the policy documents), extract features of the text, and label the parts of speech to prepare a consistent framework of labeled text for further processing. For example, the interpretation engine 202 may label certain words or phrases as nouns and verbs that reflect the basic instructions. The interpretation engine 202 may include or be a part of a natural language processor (NLP).

Next the labeled text may be processed using a classifier 204, which analyzes the labeled text to identify policies and features of each policy. The output of the classifier 204, referred to herein as policy actions, may be a set of structured policy descriptions extracted from the policy document text. For example, each policy description may be formatted to include a policy subject, one more required actions related to the policy subject, and one or more variables that provide boundaries for the required actions. The classifier 204 may be any suitable type of classifier, including a Naive Bayes classifier, support vector machine, and others.

Next the policy actions are used by the model trainer 206 as input training data for generating the trained model 128. The model trainer 206 performs training to generate parameters of the trained model 128 using the policy actions output by the classifier and the known compliance assets. The trained model 128 may use any suitable type of artificial intelligence (AI) algorithm or machine learning algorithm, including but not limited to pattern matching algorithms, decision tables, decision trees, artificial neural networks, and others. The training process will vary depending on the type of AI implemented.

In some embodiments, the model trainer 206 may be used to train an artificial neural network (ANN) to create a mapping between the structured policy actions output by the classifier 204 and the desired policy action codes. To generate the neural network, the model trainer 206 may first select values for the hyperparameters of the neural network. The hyperparameters may be any parameters that affect the structure of the neural network, such as the number of hidden layers and the number of neurons in each hidden layer, or determine how the neural network is trained, such as the learning rate and batch size, among others.

Training the neural network means computing the values of the neural network's weights and biases to minimize a cost function. Any suitable cost function may be used. The neural network is fed input training samples, and the cost function consists of terms that can be calculated based on a comparison of the neural network's output and the corresponding output training samples. The neural network may be a feedforward neural network trained using a technique or a feed forward technique and using any suitable training algorithm, including backpropagation, a gradient descent algorithm, and/or a mini-batch technique. The neural network may also be a recurrent neural network, a convolutional neural network, an autoencoder, an encoder-decoder network, and others.

When the neural network is finished training, the trained neural network can be tested using a portion of the training data 124 as test data and comparing the neural network's outputs with the corresponding output test samples. An error value may be computed for each test sample and the distribution of test sample errors or any derived properties, like its mode or mean, may be computed. This process can be iterated until the testing error is within acceptable limits. The weights, biases, and hyperparameters of the resulting neural network may be used as the model parameters 126 of the trained model 128.

Together, the interpretation engine 202, the classifier 204, and the model trainer 206 operate as a natural language processor that can provide a machine translation of policy documents 120 into the policy action code that can be used to build infrastructure, services, security, or other compute assets. It will be appreciated that various alterations may be made to the standards processor and that some components may be omitted or added without departing from the scope of the disclosure. For example, the standards processor 118 may use or include any suitable natural language processing techniques.

FIG. 3 is a block diagram of an example asset generator 116 in accordance with some embodiments of the present disclosure. The asset generator 116 may be implemented in hardware or a combination of hardware a software and any suitable type of computing architecture.

As described above, the asset generator 116 receives policy documents 120 and processes the policy documents to generate compliance assets 122. In this embodiment, the asset generator 116 includes the trained model 128 generated by the standards processor 118 and may also include the interpretation engine 202 and the classifier 204. The interpretation engine 202 receives the input policy documents, extracts features of the text, and labels the parts of speech to prepare a consistent framework for further processing in the same or similar manner as described in relation to FIG. 2. The labeled text may then be processed by the classifier 204, which analyzes the labeled text to identify policies and features of each policy, as described in relation to FIG. 2, to generate a set of structured policies extracted from the policy document text.

Next the policy actions are input to the trained model 128 to generate compliance assets 122. The type of the asset generator 116 will determine the type of compliance asset 122 generated and the type of policy documents used for input. For example, in some embodiments, the policy documents 120 may be published standards and the resulting compliance assets 122 may be natural-language company policies (e.g., to be distributed to company personnel). In some embodiments, the policy documents 120 may be manually prepared company policies and the resulting compliance assets 122 may be policy actions or policy action code. In embodiments in which multiple asset generators 116 are available, the client may indicate the type of compliance asset requested, which will determine which asset generator is used.

It will be appreciated that various alterations may be made to the asset generator 116 and that some components may be omitted or added without departing from the scope of the disclosure. For example, the asset generator 116 may use or include any suitable natural language processing techniques.

FIG. 4 is another example of an asset generator 116 in accordance with some embodiments of the present disclosure. The asset generator 116 of FIG. 4 is the same or similar the asset generator of FIG. 3 and includes the interpretation engine 202, the classifier 204, and the trained model 128. However, in this example, the compliance assets include policy actions 402 and the policy action code 404. The policy actions 402 are the structured policies extracted from the policy document text (e.g., policy subject, required actions, variables). The policy actions are provided to the client and may be useful as technical documentation to be used by technology experts for manually generating additional assets. The same policy actions 402 are input to the trained model 128 to generate the policy actions code 404.

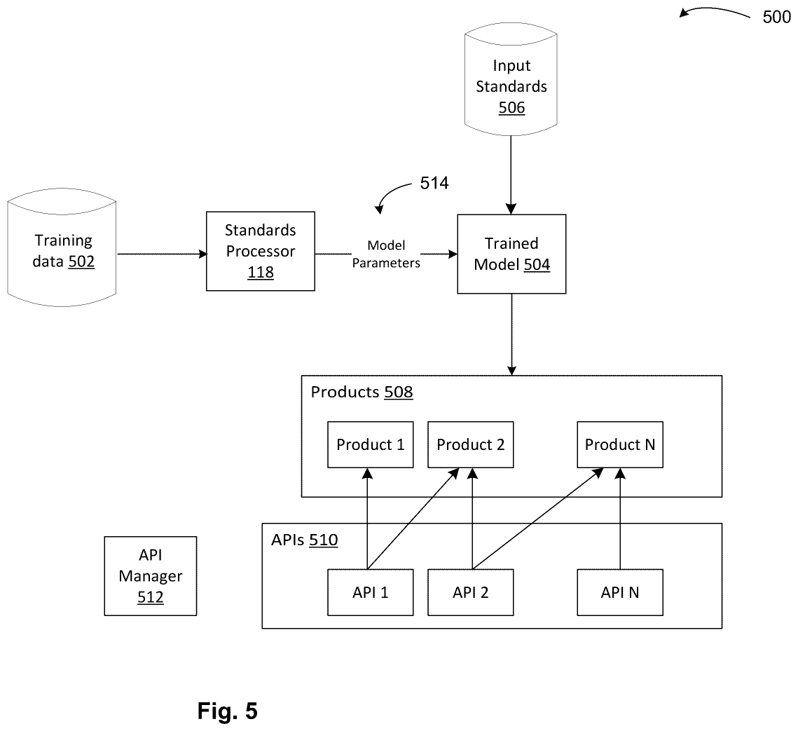

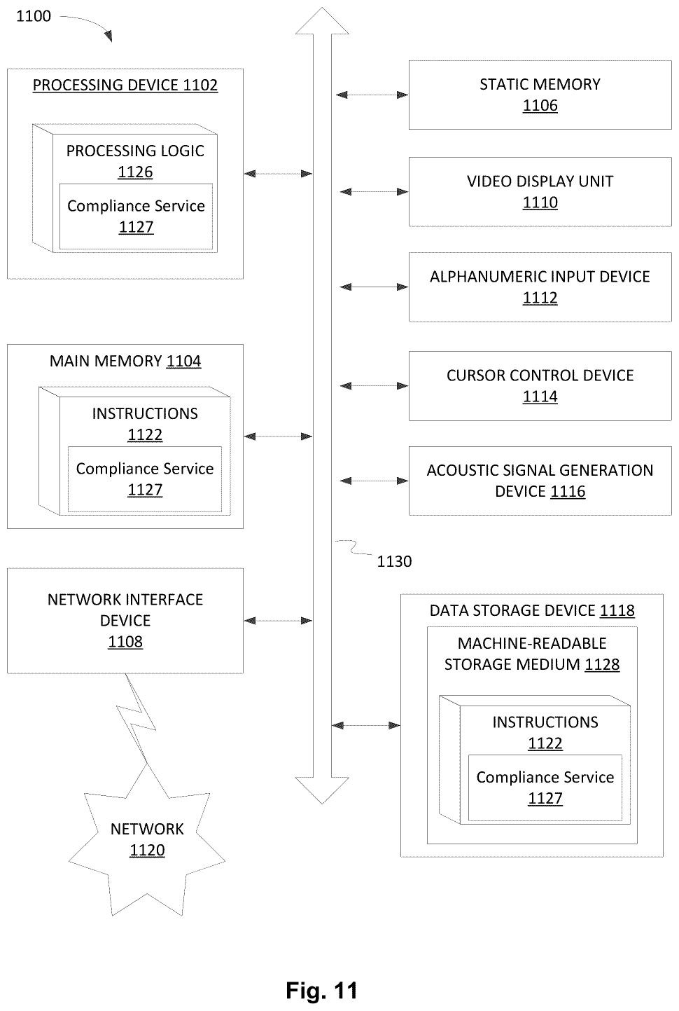

FIG. 5 is a block diagram of another example system 500 in accordance with some embodiments of the present disclosure. One skilled in the art will appreciate that other architectures are possible for system 500 and any components thereof, and that the implementation of a system utilizing examples of the disclosure are not necessarily limited to the specific architecture depicted by FIG. 5. The system 500 may be implemented in any suitable computer system, such as the computing system 1100 of FIG. 11, and may be coupled to client devices through a network 1120. The system 500 may be a cloud-based infrastructure configured, for example, as SaaS or PaaS. The computing system 500 may also be a non-cloud-based system such as a personal computer, one or more servers communicatively coupled through a network, and other configurations.

The system 500 includes the standards processor 118, an example of which is described in relation to FIG. 2. As described above, the standards processor 118 uses training data 502 to generate model parameters for a trained model 504. In this embodiment, the system 500 generates various policy compliance related assets, referred to as products 508, based on various published standards, i.e., publicly available standards that are issued by a standards organization such as ISO. Accordingly, the training data 502 includes published standards as input data. The output training data may vary depending on the product to be generated, which may be company policies (e.g., automatically generated policy documents), policy actions, policy action code, audit scripts, and others. The choice of input and output for training a particular trained model 504 depends on the applicable standard and/or the specific compliance assets to be generated, which are dictated by the product type.

The standards processor 118 generates the model parameters 514 for the trained model 504. Once trained, the trained model 540 can receive new (e.g., updated) input standards 506 and generate products 508. Although one trained model 504 is shown, it will be appreciated that there may be several separate trained models 504, each of which may be trained to provide a different type of product or products associated with a different standard. The products 508, labeled 1 though N, may include the company policies in human readable form and other types of compliance assets such as policy actions or policy action code for various standards and product types.

Client access to the various products may be facilitated by a set of Application Programming Interfaces (APIs). Each API may be configured to provide access to one or more products 508. The products 508 may be grouped in a manner to allow clients to receive a suite of compliance assets that are often purchased together such as a group of products related to a same ISO standard. The APIs 510 may be controlled by an API manager 512 that configures the APIs 510. For example, the API manager 512 may control which products 508 each API 510 links to, which may change as new products 508 are created or existing products 508 are updated, for example, in response to new training data or an updated standard 506.

A single input standard 506 may result in more than one product 508. For example, different products 508 may be generated for different sections of a standard 506. In some embodiments, when updated standards are published, the updated standard may be processed to determine which parts of the standard have been added, edited, or deleted compared to previous versions. These changes can be detected using, for example, diff tools that identify changes in text and/or cross-reference databases is used to keep track of policies. Those products that relate to standards or portions of standards that have changes may be updated. Depending on the degree of the change, the existing trained model 504 may be used to update the corresponding product. For example, a small change such as a change to the variable values of a particular policy subject may be handled by inputting the updated standard to the existing trained model, while new sections or new policy subjects may require the generation of a new trained model. Products related to standards or portions of standards that have not changed can be kept and identified as current, thereby reducing processing time.

The system 500 may provide a full suite of products to enable the client to generate policies, implement policy action codes within their computing environment, and test the computing environment for compliance. One type of product offering may be an audit scripts that can be run by the client against the client's environment to prove validation. Audit results may be uploaded by the client to the service. Another product may be a compliance analyzer that can generate the required proof points for the auditors and/or generate reports such as compliance gap analysis, risk analysis, impact analysis, etc. Gap analysis documents where more actions are required or what needs remediation. Gap analysis can also guide clients to additional compliance standards.

It will be appreciated that various alterations may be made to the system 500 and that some components may be omitted or added without departing from the scope of the disclosure. For example, other interfaces and techniques for delivering the products 508 to clients are also possible.

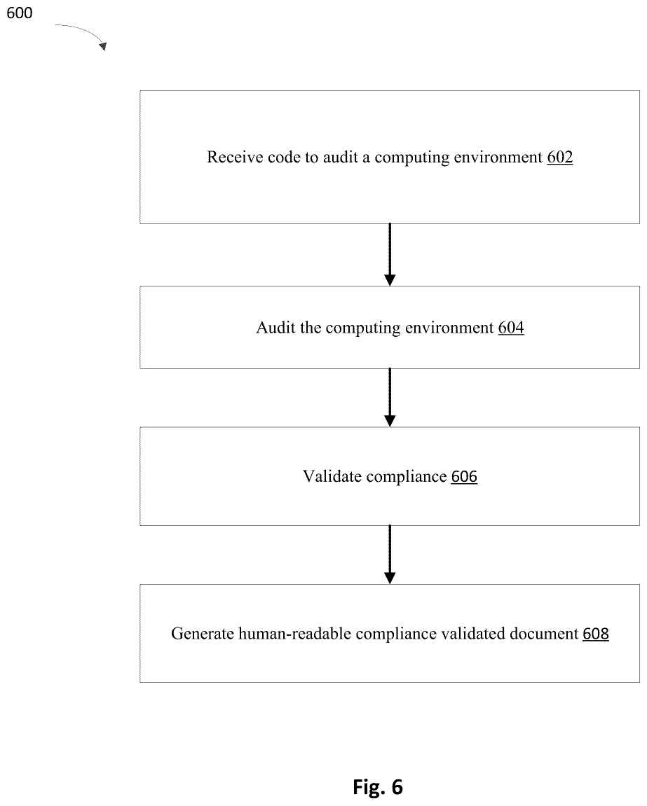

FIG. 6 is a process flow diagram summarizing a method of automatically performing an audit using generated compliance assets, in accordance with some embodiments of the present disclosure. Method 600 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 600 may be performed by the computing system 102 and/or client devices 104 of FIG. 1, the system 500 of FIG. 5, or the compliance service 1127 shown in FIG. 11. The method may begin at block 602.

At block 602, code is received for auditing a computing environment. The computing environment may be the computing environment of a client that has previously received compliance assets 122 such as infrastructure-as-code or policy-as-code, which has been used to configure the computing environment to be audited. The code may be policy action codes 404 received from the asset generator 116 shown in FIG. 3 or 4. For example, the code may be an audit script configured to automatically perform certain processes that pertain to a set of company policies or a published standard.

At block 604, the computing environment is audited. For example, the audit script is run on the computing environment, and during the audit the steps performed and the results of each step are recorded. In some embodiments, audit results may be returned to a SaaS (e.g., computing system 102) for storage and/or further processing.

At block 606, the compliance is validated. In some embodiments, the audit results may be returned to a SaaS (e.g., computing system 102) for validating compliance. In other embodiments, compliance may be validated by an automated process executed within the client's computing environment. Validating compliance may include automatically comparing the audit results with expected results.

At block 608, a human-readable compliance validation document is created. The compliance validation document may be generated automatically from the audit results. The compliance validation document may be a compliance gap analysis document that describes additional actions that are required to achieve compliance and/or what systems or processes require remediation, for example. The compliance validation document may also include an impact or risk analysis of the current environment configuration and may also suggest additional methodologies or compliance standards that may help the client achieve compliance.

It will be appreciated that embodiments of the method 600 may include additional blocks not shown in FIG. 6 and that some of the blocks shown in FIG. 6 may be omitted. Additionally, the processes associated with blocks 602 through 608 may be performed in a different order than what is shown in FIG. 6.

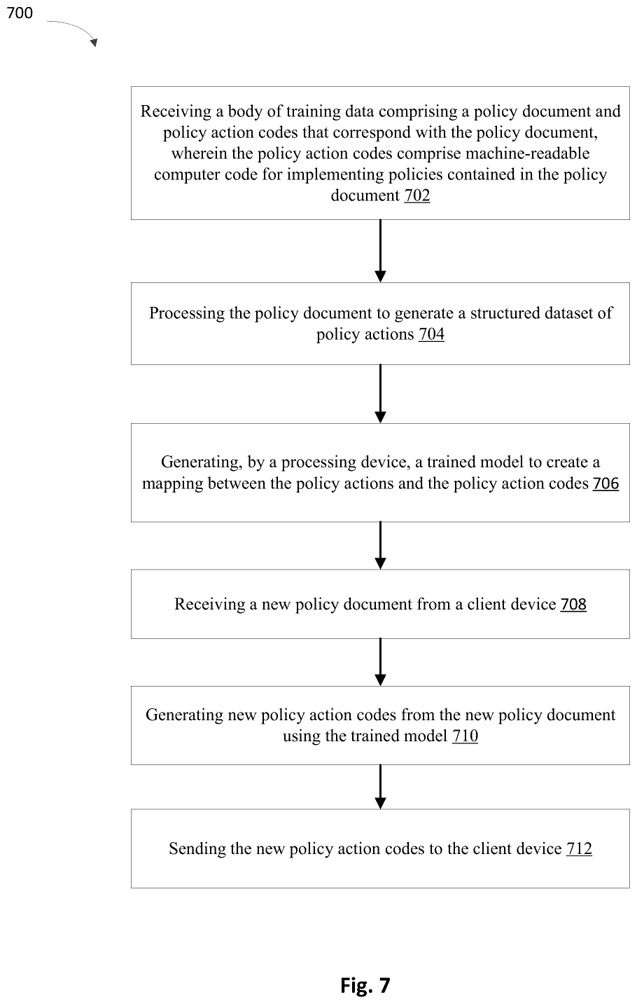

FIG. 7 is a process flow diagram summarizing a method of automatically generating compliance assets, in accordance with some embodiments of the present disclosure. Method 700 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 700 may be performed by the asset generator 116 and/or the standards processor 118 shown in FIGS. 1-4 or the compliance service 1127 shown in FIG. 11. The method may begin at block 702.

At block 702, a body of training data is received, which includes a policy document and policy action codes that correspond with the policy document, wherein the policy action codes comprise machine-readable computer code for implementing policies contained in the policy document. The training data may include several such policy documents and corresponding policy actions codes that are known to be accurate code implementations of each policy documents. The policy documents may be human-readable, natural-language text documents that describe rules and guidelines to be followed by an enterprise in operating the enterprise, creating a product, or providing a service. Additionally, the policy documents may include published standards issued by a standards organization.

At block 704, the policy document is processed to generate a structured dataset of policy actions. The policy document may be processed using one or more natural language processors and/or classifiers (e.g., interpretation engine 202, classifier 204). For example, the structured dataset of policy actions can be generated using a natural language processor to generate labeled text (e.g., nouns, verbs, etc.), and then processing the labeled text using a classifier to identify policy subjects, actions corresponding to the policy subjects, and policy variables that provide boundaries for the actions.

At block 706, a trained model is generated to create a mapping between the policy actions and the policy action codes. For example, generating the trained model may include training an artificial neural network.

At block 708, a new policy document is received from a client device.

At block 710, new policy action codes are generated from the new policy document using the trained model. For example, the new policy document can be processed to generate a new structured dataset of new policy actions in a same or similar manner to that as described in relation to block 704, and the new policy actions can be input to the trained model. The output of the trained model will be the new policy action codes. The new policy action codes may be of the same type as the policy action codes in the body of training data used to generate the trained model.

At block 712, the new policy action codes are sent to the client device. Any suitable manner of delivery may be used to send the policy action codes. In addition to the new policy actions codes, the new policy actions generated at block 710 may also be delivered.

It will be appreciated that embodiments of the method 700 may include additional blocks not shown in FIG. 7 and that some of the blocks shown in FIG. 7 may be omitted. Additionally, the processes associated with blocks 702 through 712 may be performed in a different order than what is shown in FIG. 7.

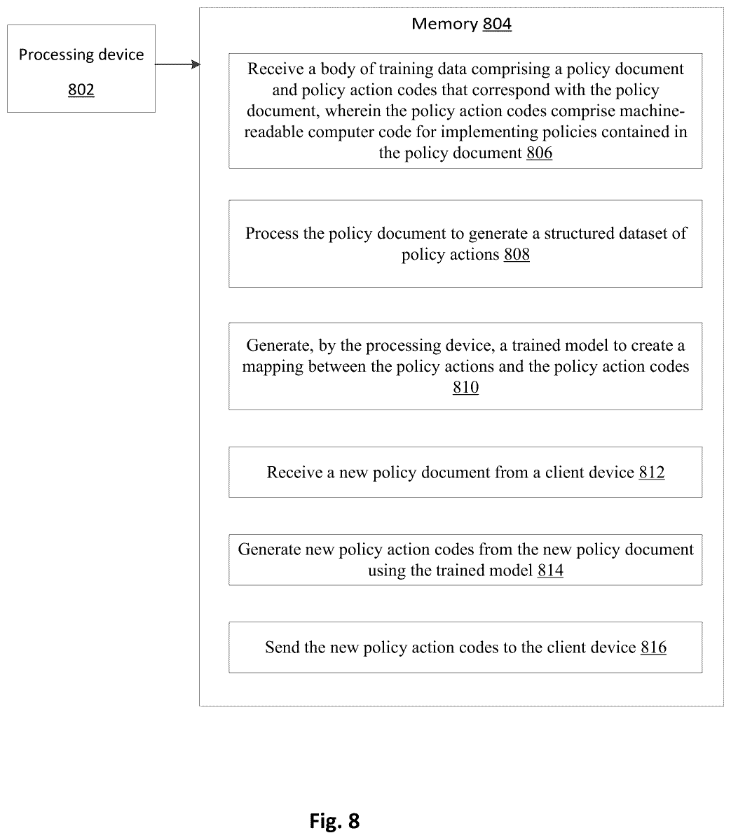

FIG. 8 is a simplified block diagram of a system for automatically generating compliance assets, in accordance with some embodiments of the present disclosure. The system 800 includes a processing device 802 operatively coupled to a memory 804. The memory 804 can include instructions that are executable by the processing device 802 to cause the processing device 802 to generate compliance assets. The processing device 802 may also be operatively coupled to a storage device (e.g., storage device 112) that includes a body of training data.

The memory 804 includes instructions 806 to receive a body of training data comprising a policy document and policy action codes that correspond with the policy document, wherein the policy action codes comprise machine-readable computer code for implementing policies contained in the policy document. The memory 804 also includes instructions 808 to process the policy document to generate a structured dataset of policy actions. The memory 804 also includes instructions 810 to generate, by the processing device, a trained model to create a mapping between the policy actions and the policy action codes. The memory 804 also includes instructions 812 to receive a new policy document from a client device. The memory 804 also includes instructions 814 to generate new policy action codes from the new policy document using the trained model. The memory 804 also includes instructions 816 to send the new policy action codes to the client device.

It will be appreciated that embodiments of the system 800 may include additional blocks not shown in FIG. 8 and that some of the blocks shown in FIG. 8 may be omitted.

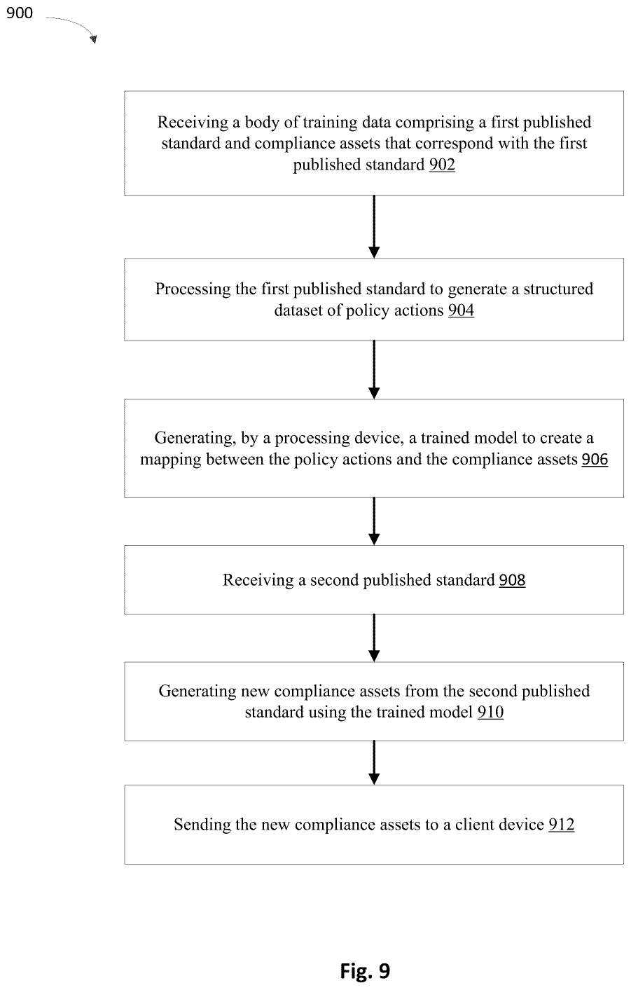

FIG. 9 is a process flow diagram summarizing another method of automatically generating compliance assets, in accordance with some embodiments of the present disclosure. Method 900 may be performed by processing logic that may include hardware, software, or a combination thereof. In some embodiments, at least a portion of method 900 may be performed by the system 500 shown in FIG. 5 or the compliance service 1127 shown in FIG. 11. The method may begin at block 902.

At block 902, a body of training data is received comprising a first published standard and compliance assets that correspond with the first published standard.

At block 904, the first published standard is processed to generate a structured dataset of policy actions.

At block 906, a trained model is generated to create a mapping between the policy actions and the compliance assets.

At block 908, a second published standard is received. In some embodiments, the second published standard may be an updated version of the first published standard.

At block 910, new compliance assets are generated from the second published standard using the trained model. The new compliance assets may be human-readable policy documents, structured policy actions, or policy action codes. The policy action codes may be machine-readable computer code for implementing policies associated with the second published standard (e.g., infrastructure-as-code, policy-as-code). The new compliance assets may also include an audit script for testing compliance of the computing infrastructure with policies associated with the second published standard.

At block 912, the new compliance assets are sent to a client device. Any suitable manner of delivery may be used to send the new compliance assets. In some embodiments, the new compliance assets are delivered via an API. For example, the new compliance assets can be grouped into a product accessible over a network through one or more APIs.

It will be appreciated that embodiments of the method 900 may include additional blocks not shown in FIG. 9 and that some of the blocks shown in FIG. 9 may be omitted. Additionally, the processes associated with blocks 902 through 912 may be performed in a different order than what is shown in FIG. 9.

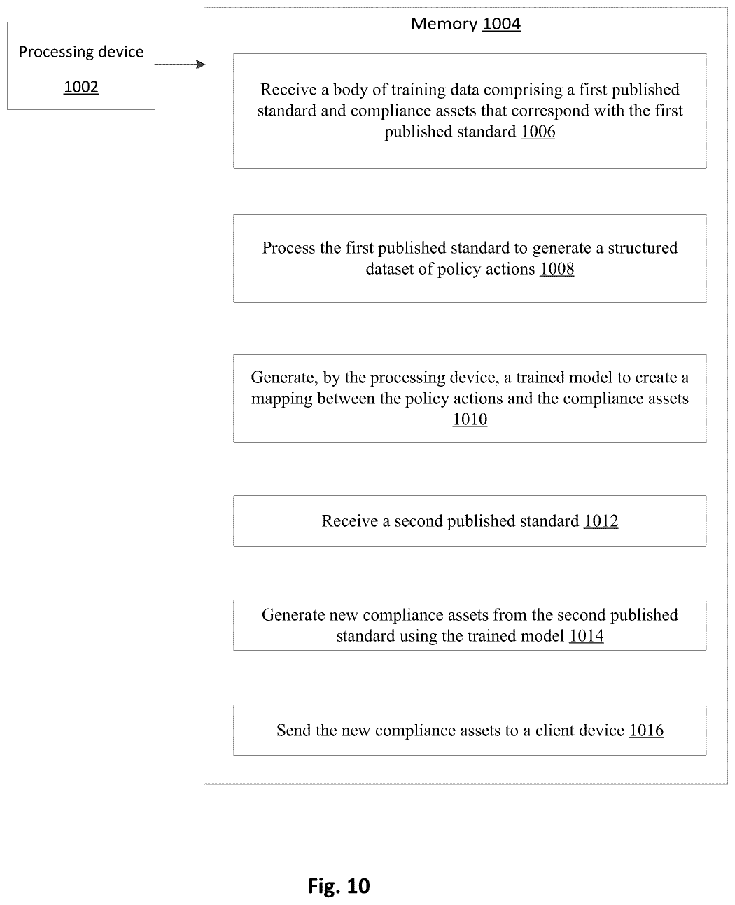

FIG. 10 is a simplified block diagram of another system for automatically generating compliance assets, in accordance with some embodiments of the present disclosure. The system 1000 includes a processing device 1002 operatively coupled to a memory 1004. The memory 1004 can include instructions that are executable by the processing device 1002 to cause the processing device 1002 to generate compliance assets. The processing device 1002 may also be operatively coupled to a storage device (e.g., storage device 112) that includes a body of training data.

The memory 1004 includes instructions 1006 to receive a body of training data comprising a first published standard and compliance assets that correspond with the first published standard. The memory 1004 also includes instructions 1008 to process the first published standard to generate a structured dataset of policy actions. The memory 1004 also includes instructions 1010 to generate, by the processing device, a trained model to create a mapping between the policy actions and the compliance assets. The memory 1004 also includes instructions 1012 to receive a second published standard. The memory 1004 also includes instructions 1014 to generate new compliance assets from the second published standard using the trained model. The memory 1004 also includes instructions 1016 to send the new compliance assets to a client device.

It will be appreciated that embodiments of the system 1000 may include additional blocks not shown in FIG. 10 and that some of the blocks shown in FIG. 10 may be omitted.

FIG. 11 illustrates a diagrammatic representation of a machine in the example form of a computer system 1100 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a web appliance, a server, and other machines capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 1100 may be representative of a server, such as a cloud server, configured as a developer platform for building, storing, testing, and distributing software packages.

The exemplary computer system 1100 includes a processing device 1102, a main memory 1104 (e.g., read-only memory (ROM), flash memory, dynamic random access memory (DRAM), a static memory 1106 (e.g., flash memory, static random access memory (SRAM), etc.), and a data storage device 1118, which communicate with each other via a bus 1130. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Processing device 1102 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 1102 may also be one or more special-purpose processing devices such as an application specific integrated circuit (ASIC), a field programmable gate array (FPGA), a digital signal processor (DSP), network processor, or the like. The processing device 1102 is configured to execute processing logic 1126 for performing the operations and steps discussed herein. For example, the processing logic 1126 may include logic for performing the functions of a compliance service 1127, which may include an asset generator 116, standards processor 118, API manager 512, and any of the other components described above in FIGS. 1-5.

The data storage device 1118 may include a machine-readable storage medium 1128, on which is stored one or more set of instructions 1122 (e.g., software) embodying any one or more of the methodologies of functions described herein, including instructions to cause the processing device 1102 to perform the functions of the compliance service 1127. The instructions 1122 may also reside, completely or at least partially, within the main memory 1104 or within the processing device 1102 during execution thereof by the computer system 1100; the main memory 1104 and the processing device 1102 also constituting machine-readable storage media. The instructions 1122 may further be transmitted or received over a network 1120 via the network interface device 1108.

While the machine-readable storage medium 1128 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Example 1 is a method. The method includes receiving a body of training data comprising a policy document and policy action codes that correspond with the policy document, wherein the policy action codes comprise machine-readable computer code for implementing policies contained in the policy document; processing the policy document to generate a structured dataset of policy actions; generating, by a processing device, a trained model to create a mapping between the policy actions and the policy action codes; receiving a new policy document from a client device; generating new policy action codes from the new policy document using the trained model; and sending the new policy action codes to the client device.

Example 2 includes the method of example 1. In this example, generating the new policy action codes includes processing the new policy document to generate a new structured dataset of new policy actions, and inputting the new policy actions to the trained model.

Example 3 includes the method of any one of examples 1 to 2. In this example, the method includes sending the new policy actions to the client device.

Example 4 includes the method of any one of examples 1 to 3. In this example, processing the policy document to generate the structured dataset of policy actions includes processing the policy document using a natural language processor to generate labeled text.

Example 5 includes the method of any one of examples 1 to 4. In this example, processing the policy document to generate the structured dataset of policy actions further includes processing the labeled text using a classifier to identify policy subjects, actions corresponding to the policy subjects, and policy variables that provide boundaries for the actions.

Example 6 includes the method of any one of examples 1 to 5. In this example, the policy document includes a human-readable, natural-language text document that describe rules and guidelines to be followed by an enterprise in operating the enterprise, creating a product, or providing a service.

Example 7 includes the method of any one of examples 1 to 6. In this example, the policy document includes a published standard issued by a standards organization.

Example 8 includes the method of any one of examples 1 to 7. In this example, the trained model is an artificial neural network, artificial intelligence model, or a machine learning model.

Example 9 is a system. The system includes a memory; and a processing device, operatively coupled to the memory, the processing device to: receive a body of training data comprising a policy document and policy action codes that correspond with the policy document, wherein the policy action codes comprise machine-readable computer code for implementing policies contained in the policy document; process the policy document to generate a structured dataset of policy actions; generate, by the processing device, a trained model to create a mapping between the policy actions and the policy action codes; receive a new policy document from a client device; generate new policy action codes from the new policy document using the trained model; send the new policy action codes to the client device; audit the computing environment using the new policy action codes to generate a human-readable compliance validated document; and store the human-readable compliance validated document in a non-transitory computer-readable storage medium

Example 10 includes the system of example 9. In this example, to generate the new policy action codes, the processing device is to: process the new policy document to generate a new structured dataset of new policy actions; and input the new policy actions to the trained model.

Example 11 includes the system of any one of examples 9 to 10. In this example, the processing device is further to send the new policy actions to the client device.

Example 12 includes the system of any one of examples 9 to 11. In this example, to process the policy document to generate the structured dataset of policy actions, the processing device is to: process the policy document using a natural language processor to generate labeled text.

Example 13 includes the system of any one of examples 9 to 12. In this example, to process the policy document to generate the structured dataset of policy actions, the processing device is further to: processing the labeled text using a classifier to identify policy subjects, actions corresponding to the policy subjects, and policy variables that provide boundaries for the actions.

Example 14 includes the system of any one of examples 9 to 13. In this example, the policy document comprises a human-readable, natural-language text document that describe rules and guidelines to be followed by an enterprise in operating the enterprise, creating a product, or providing a service.

Example 15 includes the system of any one of examples 9 to 14. In this example, the policy document comprises a published standard issued by a standards organization.

Example 16 includes the system of any one of examples 9 to 15. In this example, the trained model is an artificial neural network, artificial intelligence model, or a machine learning model.

Example 17 is a non-transitory computer-readable storage medium. The computer-readable medium includes instructions that direct the processor to receive a body of training data comprising a policy document and policy action codes that correspond with the policy document, wherein the policy action codes include machine-readable computer code for implementing policies contained in the policy document; process the policy document to generate a structured dataset of policy actions; generate a trained model to create a mapping between the policy actions and the policy action codes; receive a new policy document from a client device; generate new policy action codes from the new policy document using the trained model; and send the new policy action codes to the client device.

Example 18 includes the computer-readable medium of example 17. In this example, to process the policy document to generate the structured dataset of policy actions, the instructions cause the processing device to: process the policy document using a natural language processor to generate labeled text.

Example 19 includes the computer-readable medium of any one of examples 17 to 18. In this example, to process the policy document to generate the structured dataset of policy actions, the instructions further cause the processing device to: process the labeled text using a classifier to identify policy subjects, actions corresponding to the policy subjects, and policy variables that provide boundaries for the actions.

Example 20 includes the computer-readable medium of any one of examples 17 to 19. In this example, the policy document comprises a human-readable, natural-language text document that describe rules and guidelines to be followed by an enterprise in operating the enterprise, creating a product, or providing a service.

Example 21 is a method. The method includes receiving a body of training data comprising a first published standard and compliance assets that correspond with the first published standard; processing the first published standard to generate a structured dataset of policy actions; generating, by a processing device, a trained model to create a mapping between the policy actions and the compliance assets; receiving a second published standard; generating new compliance assets from the second published standard using the trained model; and sending the new compliance assets to a client device.

Example 22 includes the method of example 21. In this example, the second published standard is an updated version of the first published standard.

Example 23 includes the method of any one of examples 21 to 22. In this example, sending the new compliance assets to the client device comprises grouping the new compliance assets into a product accessible over a network through one or more application programming interfaces (APIs).

Example 24 includes the method of any one of examples 21 to 23. In this example, the new compliance assets include human-readable policy documents.

Example 25 includes the method of any one of examples 21 to 24. In this example, the new compliance assets comprise policy action codes comprise machine-readable computer code for implementing policies associated with the second published standard.

Example 26 includes the method of any one of examples 21 to 25. In this example, the policy action codes include infrastructure as code used to configure a computing infrastructure used by the client.

Example 27 includes the method of any one of examples 21 to 26. In this example, the new compliance assets include an audit script for testing compliance of the computing infrastructure with policies associated with the second published standard.

Example 28 is a system. The system includes a memory; and a processing device, operatively coupled to the memory, the processing device to: receive a body of training data comprising a first published standard and compliance assets that correspond with the first published standard; process the first published standard to generate a structured dataset of policy actions; generate, by the processing device, a trained model to create a mapping between the policy actions and the compliance assets; receive a second published standard; generate new compliance assets from the second published standard using the trained model; and send the new compliance assets to a client device.

Example 29 includes the system of example 28. In this example, the second published standard is an updated version of the first published standard.

Example 30 includes the system of any one of examples 28 to 29. In this example, to send the new compliance assets to the client device, the processing device is to group the new compliance assets into a product accessible over a network through one or more application programming interfaces (APIs).

Example 31 includes the system of any one of examples 28 to 30. In this example, the new compliance assets includes human-readable policy documents.

Example 32 includes the system of any one of examples 28 to 31. In this example, the new compliance assets include policy action codes comprising machine-readable computer code for implementing policies associated with the second published standard.

Example 33 includes the system of any one of examples 28 to 32. In this example, the policy action codes include infrastructure as code used to configure a computing infrastructure used by the client.

Example 34 includes the system of any one of examples 28 to 33. In this example, the new compliance assets include an audit script for testing compliance of the computing infrastructure with policies associated with the second published standard.

Example 35 is an apparatus. The apparatus includes means to receive a body of training data comprising a first published standard and compliance assets that correspond with the first published standard; means to process the first published standard to generate a structured dataset of policy actions; means to generate a trained model to create a mapping between the policy actions and the compliance assets; means to receive a second published standard; means to generate new compliance assets from the second published standard using the trained model; and means to send the new compliance assets to a client device.

Example 36 includes the apparatus of example 35. In this example, the second published standard is an updated version of the first published standard.

Example 37 includes the apparatus of any one of examples 35 to 36. In this example, the means to send the new compliance assets to the client device comprises means to: group the new compliance assets into a product accessible over a network through one or more application programming interfaces (APIs).

Example 38 includes the apparatus of any one of examples 35 to 37. In this example, the new compliance assets comprise human-readable policy documents.

Example 39 includes the apparatus of any one of examples 35 to 38. In this example, the new compliance assets comprise policy action codes comprising machine-readable computer code for implementing policies associated with the second published standard.

Example 40 includes the apparatus of any one of examples 35 to 39. In this example, the policy action codes comprise infrastructure as code used to configure a computing infrastructure used by the client.

Unless specifically stated otherwise, terms such as “receiving,” “configuring,” “training,” “identifying,” “transmitting,” “sending,” “storing,” “detecting,” “processing,” “generating” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
receiving a body of training data comprising a policy document and policy action codes that correspond with the policy document, wherein the policy action codes comprise machine-readable computer code to implement policies contained in the policy document;
processing the policy document to generate a structured dataset of policy actions;
generating, by a processing device, a trained model to create a mapping between the policy actions and the policy action codes;
receiving a new policy document from a client device;
generating new policy action codes from the new policy document using the trained model; and
sending the new policy action codes to the client device.

2. The method of claim 1, wherein generating the new policy action codes comprises:
processing the new policy document to generate a new structured dataset of new policy actions; and
inputting the new policy actions to the trained model.

3. The method of claim 2, further comprising sending the new policy actions to the client device.

4. The method of claim 1, wherein processing the policy document to generate the structured dataset of policy actions comprises processing the policy document using a natural language processor to generate labeled text.

5. The method of claim 4, wherein processing the policy document to generate the structured dataset of policy actions further comprises processing the labeled text using a classifier to identify policy subjects, actions corresponding to the policy subjects, and policy variables that provide boundaries for the actions.

6. The method of claim 1, wherein the policy document comprises a human-readable, natural-language text document that describes rules and guidelines to be followed by an enterprise in operating the enterprise, creating a product, or providing a service.

7. The method of claim 1, wherein the policy document comprises a published standard issued by a standards organization.

8. The method of claim 1, wherein the trained model is an artificial neural network, artificial intelligence model, or a machine learning model.

9. A system comprising:
a memory; and
a processing device, operatively coupled to the memory, the processing device to:
receive a body of training data comprising a policy document and policy action codes that correspond with the policy document, wherein the policy action codes comprise machine-readable computer code to implement policies contained in the policy document;
process the policy document to generate a structured dataset of policy actions;
generate, by the processing device, a trained model to create a mapping between the policy actions and the policy action codes;
receive a new policy document from a client device;
generate new policy action codes from the new policy document using the trained model;
send the new policy action codes to the client device;
audit the computing environment using the new policy action codes to generate a human-readable compliance validated document; and
store the human-readable compliance validated document in a non-transitory computer-readable storage medium.

10. The system of claim 9, wherein to generate the new policy action codes, the processing device is to:
process the new policy document to generate a new structured dataset of new policy actions; and
input the new policy actions to the trained model.

11. The system of claim 10, wherein the processing device is further to send the new policy actions to the client device.

12. The system of claim 9, wherein to process the policy document to generate the structured dataset of policy actions, the processing device is to:
process the policy document using a natural language processor to generate labeled text.

13. The system of claim 12, wherein to process the policy document to generate the structured dataset of policy actions, the processing device is further to:
processing the labeled text using a classifier to identify policy subjects, actions corresponding to the policy subjects, and policy variables that provide boundaries for the actions.

14. The system of claim 9, wherein the policy document comprises a human-readable, natural-language text document that describes rules and guidelines to be followed by an enterprise in operating the enterprise, creating a product, or providing a service.

15. The system of claim 9, wherein the policy document comprises a published standard issued by a standards organization.

16. The system of claim 9, wherein the trained model is an artificial neural network, artificial intelligence model, or a machine learning model.

17. A non-transitory computer-readable storage medium including instructions that, when executed by a processing device, cause the processing device to:
receive a body of training data comprising a policy document and policy action codes that correspond with the policy document, wherein the policy action codes comprise machine-readable computer code to implement policies contained in the policy document;
process the policy document to generate a structured dataset of policy actions;
generate, by the processing device, a trained model to create a mapping between the policy actions and the policy action codes;
receive a new policy document from a client device;
generate, by the processing device, new policy action codes from the new policy document using the trained model; and
send the new policy action codes to the client device.

18. The non-transitory computer-readable storage medium of claim 17, wherein to process the policy document to generate the structured dataset of policy actions, the instructions cause the processing device to:
process the policy document using a natural language processor to generate labeled text.

19. The non-transitory computer-readable storage medium of claim 18, wherein to process the policy document to generate the structured dataset of policy actions, the instructions further cause the processing device to:
process the labeled text using a classifier to identify policy subjects, actions corresponding to the policy subjects, and policy variables that provide boundaries for the actions.

20. The non-transitory computer-readable storage medium of claim 17, wherein the policy document comprises a human-readable, natural-language text document that describe rules and guidelines to be followed by an enterprise in operating the enterprise, creating a product, or providing a service.
